(19) United States
(12) Patent Application Publication
(10) Pub. No.: US 2026/0308721 A1
(43) Pub. Date: Oct. 8, 2026

(54) Cu-Ag ALLOY WIRE

(71) Applicant: FURUKAWA ELECTRIC CO., LTD., Tokyo (JP)

(72) Inventors: Tatsuya TAKAHASHI, Tokyo (JP); Ryosuke MATSUO, Tokyo (JP)

(21) Appl. No.: 19/157,700

(22) PCT Filed: Feb. 21, 2024
(86) PCT No.: PCT/JP2024/006161

§ 371 Date: Aug. 19, 2025

(30) Foreign Application Priority Data
Feb. 21, 2023 (JP) 2023-025498

(51) Int. Cl. C22C 9/00; C22F 1/08; H01B 1/02

(52) U.S. Cl. CPC C22C 9/00; C22F 1/08; H01B 1/026

(57) ABSTRACT

Provided is a Cu—Ag alloy wire having sufficient conductivity and high strength. A Cu—Ag allow wire according to the present invention is a Cu—Ag alloy wire having a composition containing 1 mass % or more and 6 mass % or less of Ag, the Cu—Ag alloy wire including a Cu phase as a matrix and a plurality of Ag phases as a second phase, the following formula (1) being satisfied with σ (μm²) being a sectional area of a cross-section orthogonal to a longitudinal direction of the Cu—Ag allow wire and D (μm) being a diameter of a circle having an area same as each of the Ag phases present in the cross-section:

$$\begin{matrix}[ Math . 1 ] & \\ D ≦ \sqrt{\frac{σ}{0.25 π}} \times {10}^{- 4} & Formula ( 1 )\end{matrix}$$

in which π represents a circular constant,
a ratio of the number of Ag phases having a diameter D of less than 5 nm to the total number of Ag phases being 50% or more.

### TECHNICAL FIELD

The present invention relates to a Cu—Ag alloy wire.

### BACKGROUND ART

A pure copper wire and a copper alloy wire are used as a wire material for electric and electronic devices. In the same application, as technology advances, the diameter of a solid wire is becoming thinner, and instead of a pure copper wire, which lacks sufficient strength, alloy wires such as a Cu—Sn alloy wire, a Cu—Cr alloy wire, a Cu—Ag alloy wire, or the like are increasingly being used. In recent years, electric wires such as those used in speaker coils and cables for connection to electric and electronic devices particularly tend to be further reduced in diameter due to high densification and miniaturization of electronic devices, and therefore, among copper alloys, a Cu—Ag alloy wire particularly excellent in balance between strength and conductivity has been mainly used.

Patent Documents 1 and 2 disclose techniques for improving both strength and conductivity of a Cu—Ag alloy wire by controlling a eutectic phase of Cu and Ag to a structure extended into a filament shape. Patent Document 1 discloses a technique in which a recrystallized aggregate structure is developed by heat treatment in the middle of a process, and the strength is increased by subsequent severe forming. Patent Document 2 discloses that by controlling a cooling rate during alloy casting, crystallization and precipitations are occurred finely and uniformly, and the strength of the alloy wire is increased.

However, in Patent Document 1, since an appropriate wire drawing process condition is not adopted before the heat treatment, the material becomes more brittle during the heat treatment. As a result, thinning becomes difficult, and a product having cost competitiveness is not obtained due to poor productivity. Furthermore, study on the cooling rate in the casting step is also insufficient. In Patent Document 2, promotion of precipitation by controlling distribution of the crystallization and precipitations and optimizing the intermediate heat treatment has not been studied, and there is still room for further increasing the strength. Further, Patent Documents 1 and 2 do not disclose strength characteristics in a state in which heat generation of a cable continues due to Joule heat or vibration heat generated in a cable for connection to electric and electronic devices during energization.

### CITATION LIST

### Patent Document

Patent Document 1: PCT International Publication No. WO2007/046378
Patent Document 2: Japanese Unexamined Patent Application, Publication No. 2017-2337

### DISCLOSURE OF THE INVENTION

### Problems to be Solved by the Invention

An object of the present invention is to provide a Cu—Ag alloy wire which has both high strength and high conductivity, and can maintain high strength even when used for a long period of time under high-temperature heating due to heat generation.

### Means for Solving the Problems

In order to implement the above objects, the gist of the present invention is as follows.
[1] A Cu—Ag alloy wire having a composition containing 1 mass % or more and 6 mass % or less of Ag and a balance of Cu and inevitable impurities,
the Cu—Ag alloy wire having a metal structure including a Cu phase as a matrix and a plurality of Ag phases as a second phase,
the following formula (1) being satisfied with σ being a sectional area of a cross section orthogonal to a longitudinal direction of the Cu—Ag alloy wire and D being a diameter of a true circle having an area same as each of the Ag phases present in the cross section:

$$\begin{matrix}[ Math . 1 ] & \\ D ≦ \sqrt{\frac{σ}{0.25 π}} \times {10}^{- 4} & Formula ( 1 )\end{matrix}$$

in which π represents a circular constant,
a ratio of the number of Ag phases having a diameter D of less than 5 nm to the total number of Ag phases being 50% or more.
[2] The Cu—Ag alloy wire as described in aspect [1], in which in the cross section of the Cu—Ag alloy wire,
a ratio of the number of Ag phases present on a grain boundary of the Cu phase to the total number of Ag phases is 15% or more and 35% or less.
[3] The Cu—Ag alloy wire as described in aspect [1] or [2], in which the composition further contains at least one kind of auxiliary additive element selected from the group consisting of Sn, Mg, Zn, In, Ni, Co, Zr, and Cr in a range of 0.05 mass % or more and 0.3 mass % or less.
[4] The Cu—Ag alloy wire as described in any one of aspects [1] to [3], in which the Cu—Ag alloy wire is a round wire having a wire diameter of 0.01 mm or more and 0.08 mm or less.
[5] The Cu—Ag alloy wire as described in any one of aspects [1] to [3], in which the Cu—Ag alloy wire is a ribbon wire having a substantially rectangular cross-sectional shape having a width of 0.02 mm or more and 0.32 mm or less and a thickness of 0.002 mm or more and 0.04 mm or less.

### Effects of the Invention

According to the present invention, it is possible to provide a Cu—Ag alloy wire which has both high strength and high conductivity, and can maintain high strength even when used for a long period of time under high-temperature heating due to heat generation.

### BRIEF DESCRIPTION OF THE DRAWINGS

FIG. 1 is a schematic longitudinal sectional view illustrating a metal structure when a Cu—Ag alloy wire according to the present invention is cut in a longitudinal direction thereof, and illustrates the metal structure after each manufacturing step;

FIG. 2 is a schematic longitudinal sectional view illustrating a metal structure when a Cu—Ag alloy wire in the related art is cut in a longitudinal direction thereof, and illustrates the metal structure after each manufacturing step;

FIG. 3 is a scanning transmission electron microscopic (STEM) photograph and a processed image of a Ag phase present in a cross section of the Cu—Ag alloy wire when a distribution state of the Ag phases is photographed; and

FIG. 4 is a scanning transmission electron microscope (STEM) photograph and a processed image of a grain boundary of a Ag phase present on a grain boundary of the cross section of the Cu—Ag alloy wire when a distribution state of the Ag phase is photographed.

### PREFERRED MODE FOR CARRYING OUT THE INVENTION

The present inventors have found that a Cu—Ag alloy wire having a desired metal structure and being excellent in strength and heat resistance can be obtained by optimizing a manufacturing method, particularly heat treatment conditions, in a Cu—Ag alloy wire having a predetermined composition and being manufactured by a manufacturing process including a wire drawing process, and have completed the present invention based on such knowledge.

Hereinafter, an embodiment of the present invention will be described.

### [1] Composition of Cu—Ag Alloy Wire

### <Essential Component>

The Cu—Ag alloy wire according to the present invention contains 1 mass % or more and 6 mass % or less of Ag as an essential component.

### [Ag: 1 Mass % or More and 6 Mass % or Less]

In the Cu—Ag alloy wire according to the present invention, a content of Ag is in a range of 1 mass % or more and 6 mass % or less, so that sufficient conductivity and high tensile strength can be obtained, and high strength can be maintained even when the wire is used in a heat generation state for a long period of time. In a case where the content of Ag is less than 1 mass %, a Ag phase is not sufficiently precipitated, a desired metal structure cannot be obtained, and therefore, the tensile strength is greatly reduced. On the other hand, in a case where the content of Ag exceeds 6 mass %, the conductivity is greatly reduced. Even in a case where the content of Ag exceeds 6 mass %, no further improvement in the tensile strength can be expected, and the increase in Ag content leads to an increase in cost.

In the Cu—Ag alloy wire according to the present invention, Ag (silver) is present in a state of being dissolved in a Cu phase as a matrix (first phase), or in a state of being crystallized and precipitated as a Ag phase as a second phase. Ag dissolved in the Cu phase exhibits a solid solution strengthening action, and the Ag phase crystallized and precipitated becomes a fibrous Ag phase having a fibrous shape by a wire drawing process, and exhibits a fiber strengthening action. The Ag phase, which are crystallization and precipitation, are occurred during cooling after casting and during aging heat treatment or the like, and is mainly precipitated in a cooling step after casting and first and second heat treatment steps in a manufacturing method of a Cu—Ag alloy wire according to the present invention to be described later.

### <Optional Additive Component>

The Cu—Ag alloy wire according to the present invention may contain the following components as optional additive components.

[At Least One Kind of Auxiliary Additive Element Selected from Group Consisting of Sn, Mg, Zn, in, Ni, Co, Zr, and Cr: 0.05 Mass % or More and 0.3 Mass % or Less]

Furthermore, in the Cu—Ag alloy wire according to the present invention, it is preferable that at least one component selected from the group consisting of Sn (tin), Mg (magnesium), Zn (zinc), In (indium), Ni (nickel), Co (cobalt), Zr (zirconium), and Cr (chromium) is further contained as an optional additive component in a range of 0.05 mass % or more and 0.3 mass % or less. These optional additive components are present in a state of being dissolved in Cu as a matrix (first phase), or are present as a single phase or ternary or higher crystallization and precipitation, and exhibit a solid solution strengthening action or a fiber strengthening action. Examples of the ternary or higher crystallization and precipitation include Cu—Ag—Zr. The single phase or ternary or higher crystallization and precipitation of the auxiliary additive element is precipitated during cooling after casting and during aging heat treatment.

Contents of the individual auxiliary additive elements will be described below.

### (Sn: 0.05 Mass % or More and 0.3 Mass % or Less)

Sn (tin) is an element that improves the tensile strength. In order to exhibit this effect, the content of Sn is preferably 0.05 mass % or more, more preferably 0.07 mass % or more, still more preferably 0.08 mass % or more, and particularly preferably 0.1 mass % or more. On the other hand, in a case where the content of Sn is too large, there is a concern that the conductivity may be greatly reduced, and therefore, the content of Sn is preferably 0.3 mass % or less, more preferably 0.18 mass % or less, still more preferably 0.15 mass % or less, and particularly preferably 0.12 mass % or less.

### (Mg: 0.05 Mass % or More and 0.3 Mass % or Less)

Mg (magnesium) is an element that improves the tensile strength. In order to exhibit this effect, the content of Mg is preferably 0.05 mass % or more, more preferably 0.07 mass % or more, still more preferably 0.08 mass % or more, and particularly preferably 0.1 mass % or more. On the other hand, in a case where the content of Mg is too large, there is a concern that the conductivity may be greatly reduced, and therefore, the content of Mg is preferably 0.3 mass % or less, more preferably 0.18 mass % or less, still more preferably 0.15 mass % or less, and particularly preferably 0.12 mass % or less.

### (Zn: 0.05 Mass % or More and 0.3 Mass % or Less)

Zn (zinc) is an element that improves the tensile strength. In order to exhibit this effect, the content of Zn is preferably 0.05 mass % or more, more preferably 0.07 mass % or more, still more preferably 0.08 mass % or more, and particularly preferably 0.1 mass % or more. On the other hand, in a case where the content of Zn is too large, there is a concern that the conductivity may be greatly reduced, and therefore, the content of Zn is preferably 0.3 mass % or less, more preferably 0.25 mass % or less, still more preferably 0.2 mass % or less, and particularly preferably 0.15 mass % or less.

### (In: 0.05 Mass % or More and 0.3 Mass % or Less)

In (indium) is an element that improves the tensile strength. In order to exhibit this effect, the content of In is preferably 0.05 mass % or more, more preferably 0.07 mass % or more, still more preferably 0.08 mass % or more, and particularly preferably 0.1 mass % or more. On the other hand, in a case where the content of In is too large, there is a concern that the conductivity may be greatly reduced, and therefore, the content of In is preferably 0.3 mass % or less, more preferably 0.18 mass % or less, still more preferably 0.15 mass % or less, and particularly preferably 0.12 mass % or less.

### (Ni: 0.05 Mass % or More and 0.3 Mass % or Less)

Ni (nickel) is an element that improves the tensile strength. In order to exhibit this effect, the content of Ni is preferably 0.05 mass % or more, more preferably 0.07 mass % or more, still more preferably 0.08 mass % or more, and particularly preferably 0.1 mass % or more. On the other hand, in a case where the content of Ni is too large, there is a concern that the conductivity may be greatly reduced, and therefore, the content of Ni is preferably 0.3 mass % or less, more preferably 0.25 mass % or less, still more preferably 0.2 mass % or less, and particularly preferably 0.15 mass % or less.

### (Co: 0.05 Mass % or More and 0.3 Mass % or Less)

Co (cobalt) is an element that improves the tensile strength. In order to exhibit this effect, the content of Co is preferably 0.05 mass % or more, more preferably 0.07 mass % or more, still more preferably 0.08 mass % or more, and particularly preferably 0.1 mass % or more. On the other hand, in a case where the content of Co is too large, there is a concern that the conductivity may be greatly reduced, and therefore, the content of Co is preferably 0.3 mass % or less, more preferably 0.18 mass % or less, still more preferably 0.15 mass % or less, and particularly preferably 0.12 mass % or less.

### (Zr: 0.05 Mass % or More and 0.3 Mass % or Less)

Zr (zirconium) is an element that improves the tensile strength and reduces embrittlement. In order to exhibit this effect, the content of Zr is preferably 0.05 mass % or more, more preferably 0.07 mass % or more, still more preferably 0.08 mass % or more, and particularly preferably 0.1 mass % or more. On the other hand, in a case where the content of Zr is too large, there is a concern that the conductivity may be greatly reduced, and therefore, the content of Zr is preferably 0.3 mass % or less, more preferably 0.2 mass % or less, still more preferably 0.15 mass % or less, and particularly preferably 0.12 mass % or less.

### (Cr: 0.05 Mass % or More and 0.3 Mass % or Less)

Cr (chromium) is an element that improves the tensile strength. In order to exhibit this effect, the content of Cr is preferably 0.05 mass % or more, more preferably 0.07 mass % or more, still more preferably 0.08 mass % or more, and particularly preferably 0.1 mass % or more. On the other hand, in a case where the content of Cr is too large, there is a concern that the conductivity may be greatly reduced, and therefore, the content of Cr is preferably 0.3 mass % or less, more preferably 0.18 mass % or less, still more preferably 0.15 mass % or less, and particularly preferably 0.12 mass % or less.

### [Sn, Mg, Zn, in, Ni, Co, Zr, and Cr: 0.05 Mass % or More and 1 Mass % or Less in Total]

Sn, Mg, Zn, In, Ni, Co, Zr, and Cr are preferably contained, in total, in a range of 0.05 mass % or more and 1 mass % or less, and more preferably in a range of 0.1 mass % or more and 0.5 mass % or less from the viewpoint of implementing both tensile strength and conductivity at a higher level.

### <Balance: Cu and Inevitable Impurities>

The balance is Cu (copper) and inevitable impurities except for the essential component and the optional additive components described above. Cu is the matrix of the Cu—Ag alloy wire according to the present invention, and is present in a state in which Ag or the like, which is an essential additive component, is dissolved or crystallized and precipitated. The inevitable impurities are impurities at a content level that may be inevitably contained in the manufacturing process of the Cu—Ag alloy wire according to the present invention. Examples of the inevitable impurities include Pb (lead), S (sulfur), and P (phosphorus).

### [2] Metal Structure and Shape of Cu—Ag Alloy Wire

The Cu—Ag alloy wire according to the present invention has a metal structure including a Cu phase as a matrix and a plurality of Ag phases as a second phase. The Ag phase in the Cu—Ag alloy wire according to the present invention is a fibrous Ag phase formed by the wire drawing process as described above, and there are a coarse fibrous Ag phase which is relatively large (hereinafter, also referred to as “fibrous coarse Ag phase”) and a fine fibrous Ag phase (hereinafter, also referred to as “fibrous fine Ag phase”).

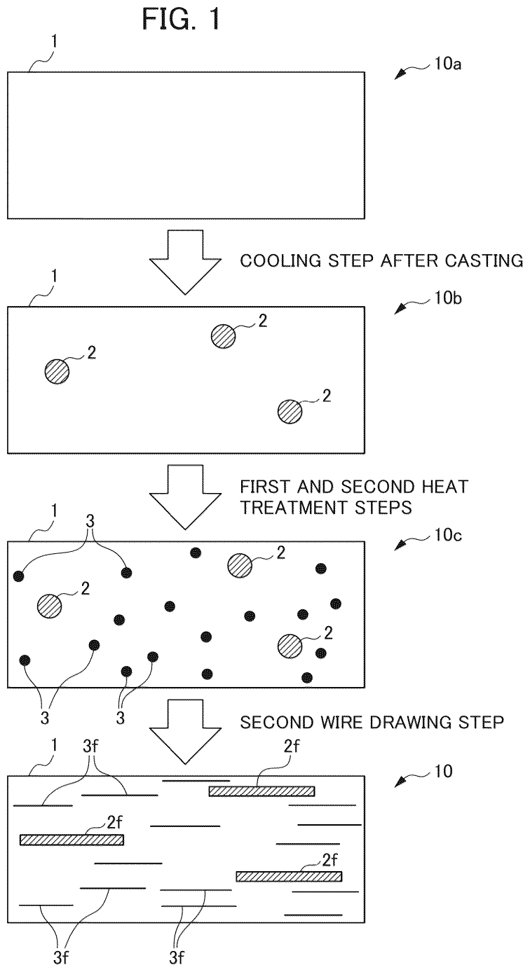

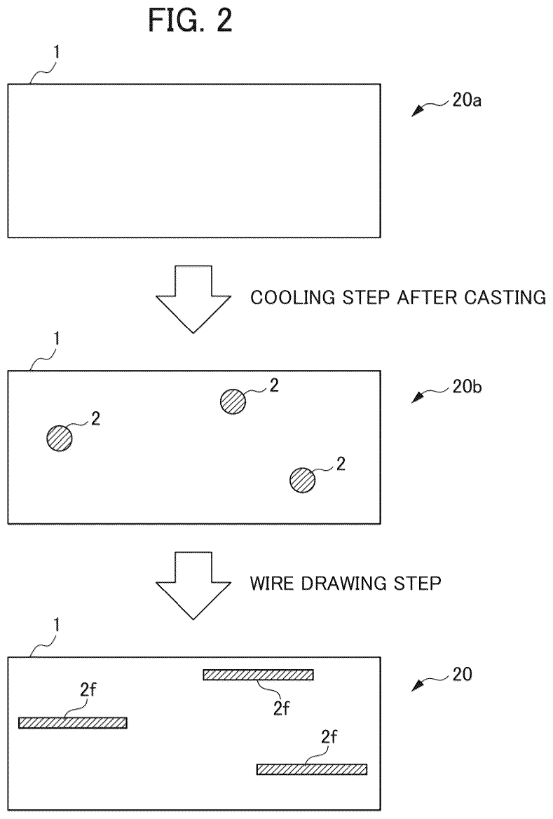

The fibrous coarse Ag phase is also present in a Cu—Ag alloy wire that is manufactured in the related art, and is mainly derived from a coarse Ag phase crystallized and precipitated during cooling after casting, as illustrated in FIG. 2. The fibrous fine Ag phase is a Ag phase characteristic to the present invention, and is particularly derived from a large number of fine Ag phases (hereinafter also referred to as “fine Ag phase”) crystallized and precipitated by the first and second heat treatment steps to be described later, as illustrated in FIG. 1. Since the fine Ag phase crystallized and precipitated in the first and second heat treatment steps usually has a size equal to or smaller than 1/10,000 of the wire diameter at the time of precipitation, the extended fibrous fine Ag phase also has the same ratio to the wire diameter. That is, the fibrous fine Ag phase refers to a phase of which a diameter D is 1/10,000 or less of the wire diameter and less than 5 nm when the cross section of the manufactured Cu—Ag alloy wire is observed. On the other hand, the fibrous coarse Ag phase refers to a phase of which the diameter D exceeds 1/10,000 of the wire diameter or 5 nm or more when observed in the same manner. A diameter of the fibrous Ag phase refers to a diameter of a perfect circle having the same area as each of the fibrous Ag phases present in the cross section. The Cu—Ag alloy wire according to the present invention has a large number of fibrous fine Ag phases 3f in addition to fibrous coarse Ag phases 2f, so that the tensile strength is remarkably improved by the fiber strengthening action.

### <Number Ratio of Fibrous Fine Ag Phase>

In the Cu—Ag alloy wire according to the present invention, the following formula (1) is satisfied when a sectional area of a cross section orthogonal to a longitudinal direction of the Cu—Ag alloy wire is denoted by σ (μm²), and the diameter of the perfect circle having the same area as each of the Ag phases present in the cross section (hereinafter, also simply referred to as “diameter of Ag phase”) is denoted by D (μm).

$$\begin{matrix}[ Math . 2 ] & \\ D ≦ \sqrt{\frac{σ}{0.25 π}} \times {10}^{- 4} & Formula ( 1 )\end{matrix}$$

(In the formula (1), π represents a circular constant.) A ratio of the number of Ag phases having a diameter D of less than 5 nm to the total number of Ag phases is 50% or more.

The ratio of the diameter of the Ag phase in the cross section of the Cu—Ag alloy wire, that is, the diameter of the section of the fibrous Ag phase satisfying the above formula (1) range is 50% or more of the total number of Ag phases, so that the tensile strength of the Cu—Ag alloy wire can be improved. When the ratio of the fine Ag phase at a level satisfying the above formula (1), that is, the fibrous fine Ag phase is high, the number of Ag phases included in the Cu—Ag alloy wire increases, so that a Cu—Ag alloy wire having the fibrous fine Ag phase at a high density can be obtained. Therefore, the number ratio of the Ag phase of which the diameter D satisfies the formula (1) is 50% or more, and preferably 60% or more. In this case, an interval between the fibrous fine Ag phases located in a vertical direction with respect to a wire drawing direction is narrowed.

In the above formula (1), a diameter d (μm) of a perfect circle having the sectional area σ is calculated based on the sectional area σ (μm²) of the alloy wire, and the ratio of the fibrous fine Ag phase having the diameter D which is a size of 1/10,000 or less of the diameter d is calculated, regardless of the shape of the Cu—Ag alloy wire. The diameter of the fibrous fine Ag phase is influenced by the final wire diameter d after wire drawing, and thus is expressed as a function of the sectional area σ calculated based on the final wire diameter d.

An average diameter of the fibrous Ag phase measured in the cross section orthogonal to the longitudinal direction is preferably in a range of 0.5 nm to 10 nm. In the Cu—Ag alloy wire according to the present invention, there is a possibility that a fibrous Ag phase having a diameter of 0.5 nm or less may be present depending on the final wire diameter, but it is very difficult, by the current technique, to detect the fibrous Ag phase having a diameter of 0.5 nm or less on the cross section and to count the number thereof, and therefore, the diameter is set to 0.5 nm or more.

Among the fibrous Ag phases described above, the average diameter measured at the cross section of the fibrous coarse Ag phase and the fibrous fine Ag phase varies depending on the final wire diameter of the Cu—Ag alloy wire as described above, but the average diameter of the fibrous fine Ag phase is, for example, 0.5 nm or more and less than 5 nm, and preferably 0.5 nm or more and 3 nm or less. On the other hand, the average diameter of the fibrous coarse Ag phase is, for example, more than 5 nm and 20.0 nm or less.

The number ratio of the fibrous fine Ag phase can be measured by the following method. First, a sample is subjected to a thinning treatment by a focused ion beam (FIB) method on a cross section perpendicular to the longitudinal direction of the Cu—Ag alloy wire. In the processing, for example, SIINT-3050TB (manufactured by SII NanoTechnology Inc.) is used and an acceleration voltage of a Ga ion beam is set to 30 kV. After the processing, Ar ion milling is performed, for example, at an acceleration voltage of 2 kV for 5 minutes in order to remove damage of the sample. The processed sample is subjected to observation of a cross section orthogonal to the longitudinal direction with a scanning transmission electron microscope (STEM). In the STEM observation, for example, JEM-ARM 200F (manufactured by JEOL Ltd.) is used to photograph a STEM bright field image and a STEM dark field image (high-angle scattering dark field image) by setting the acceleration voltage of the electron beam to 200 kV and setting an observation region to be a square having a side of 130 nm or more. By observing the cross section, since the Ag phase is continuously present in a depth direction of the observation surface, even fine precipitates of less than 5 nm may be easily detected. Then, image processing is performed on the obtained STEM dark field image with image processing software “Image J (version v1.53k)”, so that the average diameter of the Ag phase and the number of Ag phase can be calculated, and the ratio of the number of fibrous fine Ag phase can be calculated. Presence of the Ag phase may be more accurately confirmed by performing elemental analysis by energy dispersive X-ray spectroscopy (EDX) attached to STEM, at a portion where a possible contrast of the Ag phase is confirmed.

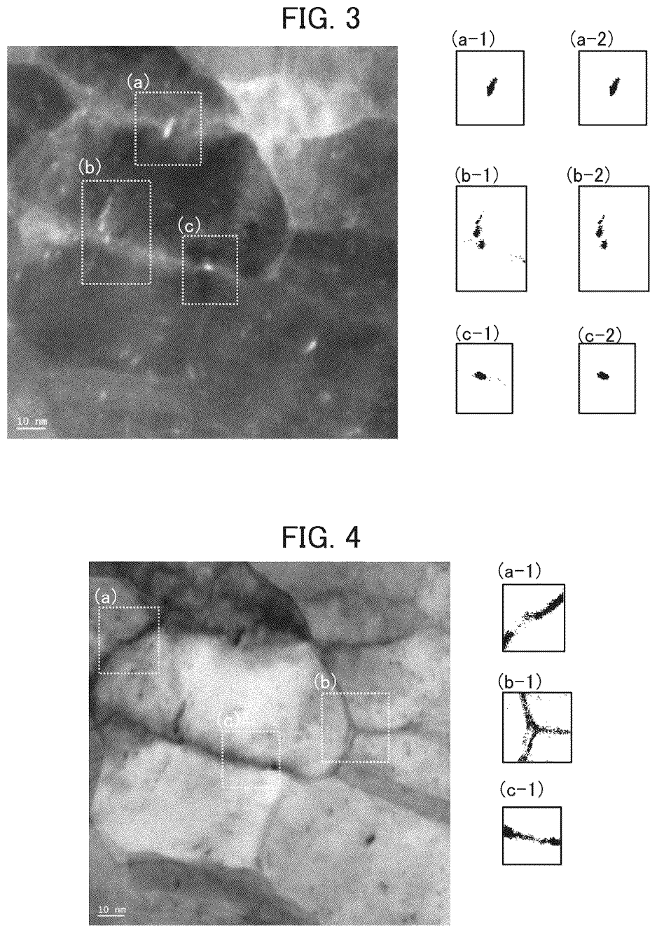

Specific procedures of the image processing will be described with reference to FIG. 3 which is an actual example. First, any range of, for example, 400 nm² to 800 nm² (left a to c in FIG. 3) is trimmed from the dark field image (left in FIG. 3), and the image is converted into gray scale. Next, in a histogram of a luminance value of the image, binarization is performed with a low luminance side as white and a high luminance side as black using top 3 to 6% as a threshold (a-1 to c-1 in FIG. 3). Further, a black portion of 10 pixels or less is removed as noise, and the residue is regarded as a Ag phase precipitate (a-2 to c-2 in FIG. 3). Then, the number of pixels of each precipitate is calculated and converted into an area, and thereafter the diameter of the precipitate is calculated based on the area on the assumption that each precipitate is a perfect circle, so that the diameter D of each precipitate, that is, the Ag phase can be calculated. Then, the total number of the Ag phase precipitate in the measurement range is counted, and the number of the Ag phase precipitate in the range of the formula (1) is counted and divided by the total number to calculate the number ratio of the fibrous fine Ag phase.

It is preferable that the Ag phase present in the Cu—Ag alloy wire is substantially continuous in the longitudinal direction and is distributed on a line. That is, the Ag phase is preferably a fibrous Ag phase (fibrous coarse Ag phase or fibrous fine Ag phase). In the related art, it has been confirmed by an analysis technique that the crystallized and precipitated coarse Ag phase is extended in the longitudinal direction by a wire drawing process and is present in the Cu—Ag alloy wire as a fibrous coarse Ag phase. Although the present description does not show an analysis result indicating the fibrous state, it may be understood rationally that the fine Ag phase crystallized and precipitated by the aging heat treatment in the present invention is also elongated in the longitudinal direction in the same manner and present in the Cu—Ag alloy wire according to the present invention as a fibrous fine Ag phase having an aspect ratio of, for example, 100 or more although the size is different.

### <Number Ratio of Ag Phase on Grain Boundary>

In the Cu—Ag alloy wire according to the present invention, the ratio of the number of Ag phase present on the grain boundary of the Cu phase to the total number of Ag phase is preferably 15% or more and 35% or less (hereinafter also referred to as “number ratio of Ag phase on grain boundary”) in the cross section of the Cu—Ag alloy wire. The number ratio of the Ag phase on the grain boundary is preferably 15% or more, and more preferably 20% or more, so that softening due to coarsening of crystal grains at the time of heat generation is suppressed by a pinning effect, and as a result, a decrease in tensile strength at the time of heat generation can be suppressed. On the other hand, the number ratio of the Ag phase on the grain boundary is preferably 35% or less from the viewpoint of suppressing grain boundary cracking due to excessive uneven distribution of second phase grains to the grain boundary and a decrease in tensile strength caused as a result.

The number ratio of the Ag phase on the grain boundary is measured by the following procedure. In the measurement, the number ratio of the Ag phase on the grain boundary can be measured by performing image processing with image processing software “Image J (version v1.53k)” using the STEM bright field image and the STEM dark field image acquired in the measurement of the number ratio of the Ag phase.

The procedure of specific image processing will be described with reference to FIG. 4 which is an actual measurement example. First, binarization processing is performed on the acquired STEM bright field image to determine the position of the grain boundary. For example, any range of 400 nm² to 800 nm² (left a to c in FIG. 4) is trimmed from the bright field image (left in FIG. 4), and the image is converted into a gray scale. Next, in a histogram of a luminance value of this image, binarization is performed using top 10% as a threshold, with a high luminance side as white and a low luminance side as black. Among black portions, for example, a black portion continuing by 15 nm or more in the longitudinal direction and having a length at a short side of 5 nm or less is defined as the grain boundary (a-1 to c-1 in FIG. 4). Regarding the STEM dark field image, the Ag phase precipitate is extracted in the same range (left a to c in FIG. 4) in accordance with the procedure described in the description of the measurement of the number ratio of the Ag phase. In FIG. 4, the measurement is performed in the same range as the range in which the precipitate is measured in FIG. 3, and therefore, FIG. 3 is used to describe the position of the precipitate. For example, any range of 400 nm² to 800 nm² (left a to c in FIG. 3) of the STEM dark field image is trimmed, and the image is converted into a gray scale. Next, in the histogram of the luminance value of the image, luminance values of the top 10% and the top 2% are compared, and when a difference thereof is 25 or more, binarization is performed using the top 2% as a threshold (a-1 to c-1 in FIG. 3). At this time, the low luminance side is set as white to be a matrix, and the high luminance side is set as black. Further, ten pixels or less of the binarized black portion are removed as noise, and the residue is defined as a Ag phase precipitate (a-2 to c-2 in FIG. 3). By comparing the position of the grain boundary (a-1 to c-1 in FIG. 4) and the position of the Ag phase precipitate (a-2 to c-2 in FIG. 3), the number ratio of the Ag phase as the precipitate on the grain boundary is calculated regarding the Ag phase partially overlapping linearly and showing the grain boundary as the precipitate on the grain boundary, and the Ag phase not overlapping at all as the precipitate not on the grain boundary but in the crystal grain.

In addition, the total number of Ag phase present per unit area of 1 μm² when measured in the cross section orthogonal to the longitudinal direction is, for example, 100 or more and 15,000 or less. From the viewpoint of improving the tensile strength, the total number of Ag phase is preferably 1,000 or more. On the other hand, from the viewpoint of ease of setting of manufacturing conditions, the total number of Ag phase is preferably 13,000 or less.

### <Shape of Cu—Ag Alloy Wire>

A shape of the Cu—Ag alloy wire according to the present invention is not particularly limited, and examples thereof include a round wire and a ribbon wire.

The Cu—Ag alloy wire according to the present invention is preferably a round wire having a wire diameter of 0.01 mm or more and 0.08 mm or less. In the market, there is a demand for a high tensile strength and high conductivity material of an ultrafine wire of 0.01 mmφ or more and 0.08 mmφ or less as a conductor used for a component. A lower limit of the wire diameter of 0.01 mmφ reflects the market needs, and if there is a demand for reduction in diameter in the future, it is possible to cope with the demand by applying the Cu—Ag alloy wire according to the present invention. In a case where the wire diameter exceeds 0.08 mmφ, the wire has a large size and cannot play a role as an ultrafine wire.

The Cu—Ag alloy wire according to the present invention is preferably a ribbon wire having a substantially rectangular cross-sectional shape with a width of 0.02 mm or more and 0.32 mm or less and a thickness of 0.002 mm or more and 0.04 mm or less. As a manufacturing method, for example, there is a method of rolling the drawn round wire into a desired shape. The ribbon-like dimension is preferably a sheet width of 0.02 mm or more and 0.32 mm or less and a sheet thickness of 0.002 mm or more and 0.04 mm or less for the same reason as the upper and lower limits of the wire diameter. The sheet width is in a mill roll width direction, the sheet thickness is in an inter-roll direction, and a mill roll non-contact portion at an end portion of the sheet width direction has a shape portion maintaining an arc while being deformed. Here, the longest value in the cross section of the ribbon wire is defined as the width, and the shortest value is defined as the thickness. Characteristics of the ribbon wire, such as the strength and the conductivity, are not greatly different from those of the circular shape before being formed into the ribbon shape.

### [3] Manufacturing Method of Cu—Ag Alloy Wire

The Cu—Ag alloy wire according to the present invention can be manufactured by a manufacturing method including, for example, a casting step [step 1], a cooling step after casting [step 2], a first wire drawing step [step 3], a first heat treatment step [step 4], a second heat treatment step [step 5], and a second wire drawing step [step 6] to be described below.

Among these steps, it is particularly important to perform the cooling step after casting [step 2], the first heat treatment step [step 4], and the second heat treatment step [step 5] under appropriate conditions in order to control the number ratio of the fibrous fine Ag phase within the range defined in the present invention. In addition, it is particularly important to perform the cooling step after casting [step 2] under appropriate conditions in order to control the number ratio of the Ag phase on the grain boundary within the range defined in the present invention.

### (i) Casting Step (Step 1)

In the manufacturing method of a Cu—Ag alloy wire according to the present invention, first, a casting step is performed in which raw materials and auxiliary additive elements are added so as to obtain a desired component composition, followed by casting and rolling, to obtain a wire rod. In this step, from the viewpoint of manufacturing efficiency, it is preferable to use a belt wheel type continuous casting and rolling mill in which a casting wheel and a belt are combined. In the mill, a wire rod can be obtained by continuously pouring molten metal into a ring-shaped groove metal mold, followed by casting and continuously rolling the molten metal.

(ii) Cooling Step after Casting (Step 2)

After obtaining a wire rod by the casting step [step 1], the cooling step after casting [step 2] is performed in which cooling is performed at a cooling rate of 60° C./sec or more and 120° C./sec or less. In a case where the cooling rate is less than 60° C./sec, the crystallization and precipitation of the coarse Ag phase becomes excessively large, and therefore, the crystallization and precipitation of the fine Ag phase in the first and second heat treatment steps [steps 4 and 5] is greatly reduced. On the other hand, in a case where the cooling rate is set to a value more than 120° C./sec, deposition of a solute (Ag) on the grain boundary is prevented, and crystallization and precipitation of the Ag phase on the grain boundary is reduced. As described above, by performing the cooling step after casting [step 2] at 60° C./sec or more, preferably 80° C./sec or more and 120° C./sec or less, a large amount of solute (Ag) is present in the vicinity of the grain boundary due to insufficient diffusion caused by rapid cooling, so that it is possible to promote crystallization and precipitation of the Ag phase on the grain boundary that behaves as pinning particles.

(iii) First Wire Drawing Step (Step 3)

Following the cooling step after casting (step 2), the first wire drawing step (step 3) is performed in which cold wire drawing is performed at a processing ratio of 50% or more and 90% or less. In a case where the processing ratio is less than 50%, crystallization and precipitation of a sufficient amount of the fine Ag phase does not occur in the aging heat treatment. In addition, in a case where the processing ratio is less than 50%, there may be a problem that a void defect grows. On the other hand, in a case where the processing ratio exceeds 90, it is difficult to perform the wire drawing process at a high processing ratio after the second heat treatment step [step 5]. Therefore, from the viewpoint of promoting the crystallization and precipitation of a sufficient amount of the fine Ag phase, suppressing void growth, and further ensuring sufficient room for the wire drawing process in a subsequent step, the first wire drawing step [step 3] is performed at a processing ratio of 50% or more and 90% or less.

Here, the “processing ratio” is a value obtained by dividing, by a sectional area before the wire drawing process, a value obtained by subtracting a sectional area after the process from the sectional area before the process, followed by multiplying by 100 and representing in percentage, and is represented by the following equation.

$$[ Process Ratio ] = \{ ( [ Sectional Area Before Process ] - \\ [ Sectional Area After Process ] ) / [ Sectional Area Before Process ] \} \times 100 ( \% )$$

The first wire drawing step [step 3] can be performed by a known method such as wire pull out drawing process using a die. The first wire drawing process may be performed in one pass or in a plurality of passes until a target wire diameter is obtained.

### (iv) First Heat Treatment Step (Step 4)

Following the first wire drawing step (step 3), the first heat treatment step (step 4) is performed. In the first heat treatment step [step 4], after holding at a holding temperature in a range of 300° C. or higher and 400° C. or lower for 2 hours or longer and 100 hours or shorter, cooling is performed to room temperature at a cooling rate of 90° C./sec or more. The holding at a predetermined temperature promotes the crystallization and precipitation of the fine Ag phase. By rapidly cooling to room temperature, residual stress derived from a difference in thermal expansion coefficient and a difference in cooling rate between the Ag phase and the matrix obtained up to this step is accumulated, and precipitation of the Ag phase in the subsequent second heat treatment step [step 5] is promoted. When the holding temperature in the first heat treatment step [step 4] is lower than 300° C., the Ag phase as a precipitate is not sufficiently generated. On the other hand, in a case where the holding temperature in the first heat treatment step [step 4] exceeds 400° C., the Ag phase which is crystallized and precipitated becomes coarse, and the number of the generated Ag phase is also reduced. Therefore, a sufficient amount of the fine Ag phase is not crystallized and precipitated. In a case where the cooling rate in the first heat treatment step [step 4] is low, a difference in shrinkage amount between the Ag phase and the matrix becomes small, and it becomes difficult to effectively accumulate strain. By performing the first heat treatment step [step 4] at a temperature in a range of a holding temperature of 300° C. or higher and 400° C. or lower and performing cooling at a cooling rate of 90° C./sec or more, the number ratio of the generated fibrous fine Ag phase can be increased.

### (v) Second Heat Treatment Step (Step 5)

Following the first heat treatment step [step 4], the second heat treatment step [step 5] is performed in which a heat treatment is performed at a temperature higher than that in the first heat treatment step. The second heat treatment step [step 5] is performed at a temperature higher than the holding temperature in the first heat treatment step [step 4] by 25° C. or higher, and is usually performed at a holding temperature in a range of 400° C. to 600° C. for a holding time of 2 hours or longer and 100 hours or shorter. Regarding cooling after holding at a predetermined temperature, natural cooling in a furnace in which heating is stopped is desirable in order to improve processability in the subsequent wire drawing step. By performing the second heat treatment step [step 5] at a higher temperature after the first heat treatment step [step 4], the precipitation and recrystallization of residual solid solution elements due to effects of diffusion ability improvement and strain accumulated at the time of cooling are promoted.

The holding time in the first heat treatment step and the second heat treatment step is preferably 10 hours or longer and 100 hours or shorter in total. By performing the two-stage heat treatment of the first heat treatment step [step 4] and the second heat treatment step [step 5], the Ag phase generated finely and in a large amount forms a high-density fibrous fine Ag phase after wire drawing, thereby increasing the strength. By performing the recrystallization step which is the second heat treatment step [step 5], the processability in the subsequent wire drawing step can be improved, and wire disconnection at the time of thinning can be prevented. When the holding temperature and the holding time do not satisfy the conditions specified above, the precipitation is insufficient due to diffusion delay of the solute (Ag), and therefore, the crystallization and precipitation of the Ag phase is greatly reduced. From the viewpoint of preventing deterioration in surface quality such as oxidation due to the heat treatment step, a stripping step may be provided after the second heat treatment step [step 5].

The first heat treatment step [step 4] and the second heat treatment step [step 5] described above can be performed using a known method such as batch heat treatment or continuous heat treatment such as high-frequency heating, electrical heating, and running heating. Regarding the cooling after the first heat treatment step [step 4], cooling by spray of a quenching solution of oil, water, or the like, immersion in the quenching solution, or jet of a non-oxidizing gas is preferred in order to obtain a desired cooling rate.

### (vi) Second Wire Drawing Step (Step 6)

After the second heat treatment step [step 5], a second wire drawing step [step 6] is performed after cooling in which cold wire drawing is performed at a processing ratio of 99.7% or more and 99.998% or less. In a case where the processing ratio is less than 99.7%, the strength is not sufficiently increased. On the other hand, it is difficult to make the processing ratio exceed 99.998% in terms of processing technique. Therefore, the second wire drawing step [step 6] is performed at a processing ratio of 99.7% or more and 99.998% or less.

The second wire drawing step can be performed by a known method such as a wire pull out drawing process using a die. The second wire drawing process may be performed in one pass or in a plurality of passes until a target wire diameter is obtained.

Although the above-described manufacturing method is mainly a manufacturing method of a circular round wire, when a ribbon-shaped ribbon wire is to be manufactured, the ribbon wire can be manufactured by rolling and processing the round wire manufactured in a circular shape by the above-described manufacturing method to a predetermined thickness.

Although the embodiment of the present invention has been described above, the present invention is not limited to the above embodiment, and various modifications can be made within the scope of the present invention, including all aspects included in the concept and claims of the present invention.

### EXAMPLES

Next, examples and comparative examples will be described, but the present invention is not limited to these examples.

### 1. Experiment 1: Manufacture and Evaluation of Cu—Ag Alloy Wire

Cu—Ag alloy wires of Examples and Comparative Examples were produced by the following manufacturing method.

### <Manufacturing Method>

### Examples 1-1 to 1-11

A raw material of Cu-1.0 mass % Ag was melted in the air, and an ingot cast into a wire rod was subjected to a cooling step after casting and a first wire drawing step under conditions shown in Table 1. Next, a first heat treatment step, a second heat treatment step, and a second wire drawing step after natural cooling in a furnace after heating was stopped in the second heat treatment step were performed under the conditions shown in Table 1 to obtain Cu—Ag alloy wires of Examples 1-1 to 1-11. In Examples 1 to 9, which are ribbon wires, the ribbon wires were once formed into round wires and then formed into ribbon wires having dimensions shown in Table 5.

### Comparative Examples 1-1 to 1-11

Cu—Ag alloy wires of Comparative Examples 1-1 to 1-11 were obtained by performing manufacture in the same procedure as that of Examples 1-1 to 1-11 under conditions shown in Table 1 except that among Comparative Examples 1-1 to 1-11, the first heat treatment step and the second heat treatment step were not performed in Comparative Examples 1-1 and 1-2, the second heat treatment step was not performed in Comparative Example 1-4, and the first heat treatment was not performed in Comparative Example 1-5.

TABLE 1
(Cu-1.0 mass % Ag alloy wire)

| | Manufacturing condition | | | | | | | |
|---|---|---|---|---|---|---|---|---|
| | Cooling | First wire | | | | | | Second wire |
| | step after | drawing | First heat | | | Second heat | | drawing |
| | casting | step | treatment step | | | treatment step | | step |
| | Cooling | Processing | Holding | Holding | Cooling | Holding | Holding | Processing |
| | rate | ratio | temperature | time | rate | temperature | time | ratio |
| | (° C./sec) | (%) | (° C.) | (h) | (° C./s) | (° C.) | (h) | (%) |
| Example 1-1 | 80 | 60 | 350 | 10 | 100 | 450 | 10 | 99.998 |
| Example 1-2 | 60 | 60 | 350 | 10 | 100 | 450 | 10 | 99.998 |
| Example 1-3 | 120 | 60 | 300 | 10 | 100 | 450 | 10 | 99.998 |
| Example 1-4 | 80 | 60 | 350 | 15 | 100 | 450 | 10 | 99.998 |
| Example 1-5 | 80 | 70 | 350 | 20 | 100 | 450 | 10 | 99.998 |
| Example 1-6 | 100 | 60 | 350 | 10 | 100 | 400 | 10 | 99.998 |
| Example 1-7 | 80 | 60 | 350 | 10 | 100 | 450 | 15 | 99.998 |
| Example 1-8 | 80 | 60 | 350 | 10 | 100 | 450 | 20 | 99.998 |
| Example 1-9 | 80 | 60 | 350 | 10 | 100 | 450 | 10 | 99.99 |
| Example 1-10 | 80 | 55 | 350 | 10 | 100 | 450 | 10 | 99.7 |
| Example 1-11 | 80 | 90 | 350 | 10 | 100 | 450 | 10 | 99.998 |
| Comparative | 80 | 60 | — | — | — | — | — | 99.998 |
| Example1-1 | | | | | | | | |
| Comparative | 550 | 60 | — | — | — | — | — | 99.998 |
| Example1-2 | | | | | | | | |
| Comparative | 25 | 60 | 350 | 10 | 100 | 450 | 10 | 95 |
| Example1-3 | | | | | | | | |
| Comparative | 80 | 60 | 350 | 10 | 100 | — | — | 99.998 |
| Example1-4 | | | | | | | | |
| Comparative | 80 | 60 | — | — | — | 450 | 10 | 99.998 |
| Example1-5 | | | | | | | | |
| Comparative | 80 | 60 | 200 | 10 | 100 | 450 | 10 | 99.998 |
| Example1-6 | | | | | | | | |
| Comparative | 80 | 60 | 600 | 10 | 100 | 450 | 10 | 99.998 |
| Example1-7 | | | | | | | | |
| Comparative | 80 | 60 | 350 | 1 | 100 | 450 | 10 | 99.998 |
| Example1-8 | | | | | | | | |
| Comparative | 80 | 60 | 350 | 10 | 100 | 200 | 10 | 99.998 |
| Example1-9 | | | | | | | | |
| Comparative | 80 | 60 | 350 | 10 | 10 | 600 | 10 | 99.998 |
| Example1-10 | | | | | | | | |
| Comparative | 80 | 60 | 350 | 10 | 100 | 450 | 1 | 99.998 |
| Example1-11 | | | | | | | | |

*Manufacturing conditions outside a range of manufacturing conditions described in a manufacturing method of a Cu—Ag alloy wire in the description are indicated by underlines and italics.

### Examples 2-1 to 2-11

A raw material of Cu-2.0 mass % Ag was melted in the air, and an ingot cast into a wire rod was subjected to a cooling step after casting and a first wire drawing step under conditions shown in Table 2. Next, a first heat treatment step, a second heat treatment step, and a second wire drawing step after natural cooling in a furnace after heating was stopped in the second heat treatment step were performed under the conditions shown in Table 2 to obtain Cu—Ag alloy wires of Examples 2-1 to 2-11. In Examples 2 to 9, which are ribbon wires, the ribbon wires were once formed into round wires and then formed into ribbon wires having dimensions shown in Table 6.

### Comparative Examples 2-1 to 2-11

Cu—Ag alloy wires of Comparative Examples 2-1 to 2-11 were obtained by performing manufacture in the same procedure as that of Examples 2-1 to 2-11 under conditions shown in Table 2 except that among Comparative Examples 2-1 to 2-11, the first heat treatment step and the second heat treatment step were not performed in Comparative Examples 2-1 and 2-2, the second heat treatment step was not performed in Comparative Example 2-4, and the first heat treatment was not performed in Comparative Example 2-5.

TABLE 2
(Cu-2.0 mass % Ag alloy wire)

| | Manufacturing condition | | | | | | | |
|---|---|---|---|---|---|---|---|---|
| | Cooling | First wire | | | | | | Second wire |
| | step after | drawing | First heat | | | Second heat | | drawing |
| | casting | step | treatment step | | | treatment step | | step |
| | Cooling | Processing | Holding | Holding | Cooling | Holding | Holding | Processing |
| | rate | ratio | temperature | time | rate | temperature | time | ratio |
| | (° C./sec) | (%) | (° C.) | (h) | (° C./s) | (° C.) | (h) | (%) |
| Example 2-1 | 80 | 60 | 350 | 10 | 100 | 450 | 10 | 99.998 |
| Example 2-2 | 60 | 60 | 350 | 10 | 100 | 450 | 10 | 99.998 |
| Example 2-3 | 120 | 60 | 300 | 10 | 100 | 450 | 10 | 99.998 |
| Example 2-4 | 80 | 60 | 350 | 15 | 100 | 450 | 10 | 99.998 |
| Example 2-5 | 80 | 70 | 350 | 20 | 100 | 450 | 10 | 99.998 |
| Example 2-6 | 100 | 60 | 350 | 10 | 100 | 400 | 10 | 99.998 |
| Example 2-7 | 80 | 60 | 350 | 10 | 100 | 450 | 15 | 99.998 |
| Example 2-8 | 80 | 60 | 350 | 10 | 100 | 450 | 20 | 99.998 |
| Example 2-9 | 80 | 60 | 350 | 10 | 100 | 450 | 10 | 99.99 |
| Example 2-10 | 80 | 55 | 350 | 10 | 100 | 450 | 10 | 99.7 |
| Example 2-11 | 80 | 90 | 350 | 10 | 100 | 450 | 10 | 99.998 |
| Comparative | 80 | 60 | — | — | — | — | — | 99.998 |
| Example2-1 | | | | | | | | |
| Comparative | 550 | 60 | — | — | — | — | — | 99.998 |
| Example2-2 | | | | | | | | |
| Comparative | 25 | 60 | 350 | 10 | 100 | 450 | 10 | 95 |
| Example2-3 | | | | | | | | |
| Comparative | 80 | 60 | 350 | 10 | 100 | — | — | 99.998 |
| Example2-4 | | | | | | | | |
| Comparative | 80 | 60 | — | — | — | 450 | 10 | 99.998 |
| Example2-5 | | | | | | | | |
| Comparative | 80 | 60 | 200 | 10 | 100 | 450 | 10 | 99.998 |
| Example2-6 | | | | | | | | |
| Comparative | 80 | 60 | 600 | 10 | 100 | 450 | 10 | 99.998 |
| Example2-7 | | | | | | | | |
| Comparative | 80 | 60 | 350 | 1 | 100 | 450 | 10 | 99.998 |
| Example2-8 | | | | | | | | |
| Comparative | 80 | 60 | 350 | 10 | 100 | 200 | 10 | 99.998 |
| Example2-9 | | | | | | | | |
| Comparative | 80 | 60 | 350 | 10 | 10 | 600 | 10 | 99.998 |
| Example2-10 | | | | | | | | |
| Comparative | 80 | 60 | 350 | 10 | 100 | 450 | 1 | 99.998 |
| Example2-11 | | | | | | | | |

*Manufacturing conditions outside a range of manufacturing conditions described in a manufacturing method of a Cu—Ag alloy wire in the description are indicated by underlines and italics.

### Examples 3-1 to 3-11

A raw material of Cu-4.0 mass % Ag was melted in the air, and an ingot cast into a wire rod was subjected to a cooling step after casting and a first wire drawing step under conditions shown in Table 3. Next, a first heat treatment step, a second heat treatment step, and a second wire drawing step after natural cooling in a furnace after heating was stopped in the second heat treatment step were performed under conditions shown in Table 3 to obtain Cu—Ag alloy wires of Examples 3-1 to 3-11. In Examples 3 to 9, which are ribbon wires, the ribbon wires were once formed into round wires and then formed into ribbon wires having dimensions shown in Table 7.

### Comparative Examples 3-1 to 3-11

Cu—Ag alloy wires of Comparative Examples 3-1 to 3-11 were obtained by performing manufacture in the same procedure as that of Examples 3-1 to 3-11 under conditions shown in Table 3 except that among Comparative Examples 3-1 to 3-11, the first heat treatment step and the second heat treatment step were not performed in Comparative Examples 1-1 and 1-2, the second heat treatment step was not performed in Comparative Example 1-4, and the first heat treatment was not performed in Comparative Example 1-5.

TABLE 3
(Cu-4.0 mass % Ag alloy wire)

| | Manufacturing condition | | | | | | | |
|---|---|---|---|---|---|---|---|---|
| | Cooling | First wire | | | | | | Second wire |
| | step after | drawing | First heat | | | Second heat | | drawing |
| | casting | step | treatment step | | | treatment step | | step |
| | Cooling | Processing | Holding | Holding | Cooling | Holding | Holding | Processing |
| | rate | ratio | temperature | time | rate | temperature | time | ratio |
| | (° C./sec) | (%) | (° C.) | (h) | (° C./s) | (° C.) | (h) | (%) |
| Example 3-1 | 80 | 60 | 350 | 10 | 100 | 450 | 10 | 99.998 |
| Example 3-2 | 60 | 60 | 350 | 10 | 100 | 450 | 10 | 99.998 |
| Example 3-3 | 120 | 60 | 300 | 10 | 100 | 450 | 10 | 99.998 |
| Example 3-4 | 80 | 60 | 350 | 15 | 100 | 450 | 10 | 99.998 |
| Example 3-5 | 80 | 70 | 350 | 20 | 100 | 450 | 10 | 99.998 |
| Example 3-6 | 100 | 60 | 350 | 10 | 100 | 400 | 10 | 99.998 |
| Example 3-7 | 80 | 60 | 350 | 10 | 100 | 450 | 15 | 99.998 |
| Example 3-8 | 80 | 60 | 350 | 10 | 100 | 450 | 20 | 99.998 |
| Example 3-9 | 80 | 60 | 350 | 10 | 100 | 450 | 10 | 99.99 |
| Example 3-10 | 80 | 55 | 350 | 10 | 100 | 450 | 10 | 99.7 |
| Example 3-11 | 80 | 90 | 350 | 10 | 100 | 450 | 10 | 99.998 |
| Comparative | 80 | 60 | — | — | — | — | — | 99.998 |
| Example3-1 | | | | | | | | |
| Comparative | 550 | 60 | — | — | — | — | — | 99.998 |
| Example3-2 | | | | | | | | |
| Comparative | 25 | 60 | 350 | 10 | 100 | 450 | 10 | 95 |
| Example3-3 | | | | | | | | |
| Comparative | 80 | 60 | 350 | 10 | 100 | — | — | 99.998 |
| Example3-4 | | | | | | | | |
| Comparative | 80 | 60 | — | — | — | 450 | 10 | 99.998 |
| Example3-5 | | | | | | | | |
| Comparative | 80 | 60 | 200 | 10 | 100 | 450 | 10 | 99.998 |
| Example3-6 | | | | | | | | |
| Comparative | 80 | 60 | 600 | 10 | 100 | 450 | 10 | 99.998 |
| Example3-7 | | | | | | | | |
| Comparative | 80 | 60 | 350 | 1 | 100 | 450 | 10 | 99.998 |
| Example3-8 | | | | | | | | |
| Comparative | 80 | 60 | 350 | 10 | 100 | 200 | 10 | 99.998 |
| Example3-9 | | | | | | | | |
| Comparative | 80 | 60 | 350 | 10 | 10 | 600 | 10 | 99.998 |
| Example3-10 | | | | | | | | |
| Comparative | 80 | 60 | 350 | 10 | 100 | 450 | 1 | 99.998 |
| Example3-11 | | | | | | | | |

*Manufacturing conditions outside a range of manufacturing conditions described in a manufacturing method of a Cu—Ag alloy wire in the description are indicated by underlines and italics.

### Examples 4-1 to 4-11

A raw material of Cu-6.0 mass % Ag was melted in the air, and an ingot cast into a wire rod was subjected to a cooling step after casting and a first wire drawing step under conditions shown in Table 4. Next, a first heat treatment step, a second heat treatment step, and a second wire drawing step after natural cooling in a furnace after heating was stopped in the second heat treatment step were performed under conditions shown in Table 4 to obtain Cu—Ag alloy wires of Examples 4-1 to 4-11. In Examples 4 to 9, which are ribbon wires, the ribbon wires were once formed into round wires and then formed into ribbon wires having dimensions shown in Table 8.

### Comparative Examples 4-1 to 4-11

Cu—Ag alloy wires of Comparative Examples 4-1 to 4-11 were obtained by performing manufacture in the same procedure as that of Examples 4-1 to 4-11 under conditions shown in Table 4 except that among Comparative Examples 4-1 to 4-11, the first heat treatment step and the second heat treatment step were not performed in Comparative Examples 4-1 and 4-2, the second heat treatment step was not performed in Comparative Example 4-4, and the first heat treatment was not performed in Comparative Example 4-5.

TABLE 4
(Cu-6.0 mass % Ag alloy wire)

| | Manufacturing condition | | | | | | | |
|---|---|---|---|---|---|---|---|---|
| | Cooling | First wire | | | | | | Second wire |
| | step after | drawing | First heat | | | Second heat | | drawing |
| | casting | step | treatment step | | | treatment step | | step |
| | Cooling | Processing | Holding | Holding | Cooling | Holding | Holding | Processing |
| | rate | ratio | temperature | time | rate | temperature | time | ratio |
| | (° C./sec) | (%) | (° C.) | (h) | (° C./s) | (° C.) | (h) | (%) |
| Example 4-1 | 80 | 60 | 350 | 10 | 100 | 450 | 10 | 99.998 |
| Example 4-2 | 60 | 60 | 350 | 10 | 100 | 450 | 10 | 99.998 |
| Example 4-3 | 120 | 60 | 300 | 10 | 100 | 450 | 10 | 99.998 |
| Example 4-4 | 80 | 60 | 350 | 15 | 100 | 450 | 10 | 99.998 |
| Example 4-5 | 80 | 70 | 350 | 20 | 100 | 450 | 10 | 99.998 |
| Example 4-6 | 100 | 60 | 350 | 10 | 100 | 400 | 10 | 99.998 |
| Example 4-7 | 80 | 60 | 350 | 10 | 100 | 450 | 15 | 99.998 |
| Example 4-8 | 80 | 60 | 350 | 10 | 100 | 450 | 20 | 99.998 |
| Example 4-9 | 80 | 60 | 350 | 10 | 100 | 450 | 10 | 99.99 |
| Example 4-10 | 80 | 55 | 350 | 10 | 100 | 450 | 10 | 99.7 |
| Example 4-11 | 80 | 90 | 350 | 10 | 100 | 450 | 10 | 99.998 |
| Comparative | 80 | 60 | — | — | — | — | — | 99.998 |
| Example4-1 | | | | | | | | |
| Comparative | 550 | 60 | — | — | — | — | — | 99.998 |
| Example4-2 | | | | | | | | |
| Comparative | 25 | 60 | 350 | 10 | 100 | 450 | 10 | 95 |
| Example4-3 | | | | | | | | |
| Comparative | 80 | 60 | 350 | 10 | 100 | — | — | 99.998 |
| Example4-4 | | | | | | | | |
| Comparative | 80 | 60 | — | — | — | 450 | 10 | 99.998 |
| Example4-5 | | | | | | | | |
| Comparative | 80 | 60 | 200 | 10 | 100 | 450 | 10 | 99.998 |
| Example4-6 | | | | | | | | |
| Comparative | 80 | 60 | 600 | 10 | 100 | 450 | 10 | 99.998 |
| Example4-7 | | | | | | | | |
| Comparative | 80 | 60 | 350 | 1 | 100 | 450 | 10 | 99.998 |
| Example4-8 | | | | | | | | |
| Comparative | 80 | 60 | 350 | 10 | 100 | 200 | 10 | 99.998 |
| Example4-9 | | | | | | | | |
| Comparative | 80 | 60 | 350 | 10 | 10 | 600 | 10 | 99.998 |
| Example4-10 | | | | | | | | |
| Comparative | 80 | 60 | 350 | 10 | 100 | 450 | 1 | 99.998 |
| Example4-11 | | | | | | | | |

*Manufacturing conditions outside a range of manufacturing conditions described in a manufacturing method of a Cu—Ag alloy wire in the description are indicated by underlines and italics.

### [Evaluation Method]

The Cu—Ag alloy wires of examples and comparative examples manufactured as described above were evaluated by the following evaluation methods.

### [1] Tensile Test (Manufactured Final Product)

A tensile test was performed on the Cu—Ag alloy wire as a manufactured final product. A shape of a test piece was an original linear shape, and thus did not conform to JISZ2201, but test conditions were based on JISZ2241, and a value obtained by averaging measurement results (n=2) was used as a result of the tensile strength.

An increase in the tensile strength (MPa) based on the tensile strength of the Cu—Ag alloy wire (Comparative Example 1-1, Comparative Example 2-1, Comparative Example 3-1, and Comparative Example 4-1) manufactured by a manufacturing method in the related art in which the first heat treatment step and the second heat treatment step were not performed was calculated and used as the evaluation on the tensile test. As the evaluation criteria, an increase in the tensile strength (MPa) of 100 MPa or more was evaluated as acceptable (good), and particularly, an increase in the tensile strength (MPa) of 150 MPa or more was evaluated as acceptable (excellent).

[2] Tensile Test (after Reheat Treatment)

A tensile test was performed in order to measure the tensile strength when the Cu—Ag alloy wire as a manufactured final product was subjected to a heat treatment at 250° C. for 30 minutes as the tensile strength after use in a long period of time in a heat generation state. The tensile test was performed in the same manner as the “[1] tensile test (manufactured final product)”. The heat treatment condition is a treatment time that greatly exceeds the service life of the product when converted into a heat treatment at about 80° C., which is a heat generation temperature at the time of energization, based on Larson-Miller parameter, and can be regarded as measurement on the Cu—Ag alloy wire after a long period of time in the heat generation state.

The evaluation on the tensile test was performed by comparing the tensile strength after the reheat treatment with the control Cu—Ag alloy wire manufactured by the manufacturing method in the related art in which the first heat treatment step and the second heat treatment step were not performed. A value of the tensile strength after the reheat treatment shown in Tables 5 to 8 obtained by subtracting the tensile strength after the reheat treatment of the control Cu—Ag alloy wire (Comparative Example 1-1, Comparative Example 2-1, Comparative Example 3-1, and Comparative Example 4-1) having the same composition from the measured tensile strength after the reheat treatment was used as the evaluation on the tensile strength. As for the evaluation criteria, the tensile strength higher than the target Cu—Ag alloy wire by 100 MPa or more was evaluated as acceptable (good), and the tensile strength higher than the target Cu—Ag alloy wire by 150 MPa or more was evaluated as acceptable (excellent).

### [3] Measurement of Conductivity

The conductivity of two test pieces was measured using a four-terminal method based on JIS H0505-1975 in a thermostatic chamber controlled at 20° C. (±1° C.), and an average value (% IACS) was used as the measured value. At this time, a distance between the terminals was 100 mm.

In the evaluation, in the case of Cu-1.0 mass % Ag, the conductivity of 75% IACS or more was evaluated as acceptable and the conductivity of 80% IACS or more was evaluated as excellent. In the case of Cu-2.0 mass % Ag, the conductivity of 70% IACS or more was evaluated as acceptable and the conductivity of 75% IACS or more was evaluated as excellent. In the case of Cu-4.0 mass % Ag, the conductivity of 60% IACS or more was evaluated as acceptable and the conductivity of 65% IACS or more was evaluated as excellent. In the case of Cu-6.0 mass % Ag, the conductivity of 50% IACS or more was evaluated as acceptable and the conductivity of 55% IACS or more was evaluated as excellent.

It is known in the related art that the tensile strength of the Cu—Ag alloy wire can be controlled by increasing or decreasing the Ag content, and the Cu—Ag alloy wires having different strengths of each Ag content are used for different applications. Therefore, in the above evaluation criteria, different evaluation criteria of the conductivity are set for each Ag content.

### [4] Structure Observation

Prior to image analysis of the metal structure, structure observation by STEM was performed in order to acquire a STEM bright field image and a STEM dark field image by a scanning transmission electron microscope (STEM). A measurement sample was obtained by performing a thinning treatment on the sample by a focused ion beam method (FIB) with respect to a cross section perpendicular to a longitudinal direction of the Cu—Ag alloy wire, and the processing was performed using SIINT-3050 TB (manufactured by SII NanoTechnology Inc.) at an acceleration voltage of a Ga ion beam of 30 kV. After the processing, Ar ion milling was performed at an acceleration voltage of 2 kV for 5 minutes in order to remove damage to the sample. The processed sample is subjected to observation on a cross section orthogonal to the longitudinal direction with STEM (JEM-ARM200F manufactured by JEOL Ltd.). A condition of STEM observation was an acceleration voltage of an electron beam of 200 kV. An observation region was a square having a side of 130 nm or more, and a STEM bright field image and a STEM dark field image (high-angle scattering dark field image) in the range were photographed.

### [5] Calculation of Number Ratio of Fibrous Fine Ag Phase

The acquired STEM dark field image was subjected to binarization of the Ag phase as a precipitate and calculation of the average diameter thereof as follows using image processing software “Image J (version v1.53k)”. First, any range of 400 nm² to 800 nm² was trimmed from the dark field image, and this image was converted into a gray scale. Next, in a histogram of a luminance value of the image, binarization was performed with a low luminance side as white and a high luminance side as black using top 3 to 6% as a threshold. Further, a black portion of 10 pixels or less was removed as noise, and the residue was regarded as a Ag phase precipitate. The number of pixels of each precipitate was calculated and converted into an area, and thereafter the diameter was calculated based on the area on the assumption that each precipitate is a perfect circle, so that the diameter D of each precipitate, that is, the Ag phase can be obtained. Then, the total number of the Ag phase in the measurement range was counted, and the number of the Ag phase in the range of the formula (1) was counted and divided by the total number to calculate the number ratio of the fibrous fine Ag phase.

### [6] Calculation of Number Ratio of Ag Phase on Grain Boundary

The acquired STEM bright field image was subjected to a binarization process using image processing software “Image J (version v1.53k)” to determine the position of the grain boundary. Any range of 400 nm² to 800 nm² was trimmed from the bright field image, and this image was converted into a gray scale. Next, in a histogram of a luminance value of this image, binarization was performed using top 10% as a threshold, with a high luminance side as white and a low luminance side as black. Among the black portions, a black portion continuing by 15 nm or more in the longitudinal direction and having a length at a short side of 5 nm or less was defined as the position of the grain boundary. Then, the STEM dark field image was subjected to extraction of the Ag phase precipitate using the image processing software “Image J” in the procedure shown in “[5] Calculation of Number Ratio of Fibrous Fine Ag Phase”. Any range of 400 nm² to 800 nm² was trimmed from the dark field image, and this image was converted into a gray scale. Next, in a histogram of a luminance value of the image, the luminance values of the top 10% and the top 2% were compared, and when a difference thereof is 25 or more, binarization is performed using the top 2% as a threshold. At this time, the low luminance side was set as white to be a matrix, and the high luminance side was set as black. Further, ten pixels or less of the binarized black portion was removed as noise, and the residue was defined as a Ag phase precipitate. Based on comparison with the determined position of the grain boundary, the number of Ag phase on the grain boundary was counted regarding the Ag phase partially overlapping linearly and showing the grain boundary as the precipitate on the grain boundary and the Ag phase not overlapping at all as the precipitate in the crystal grain, followed by dividing by the number of Ag phase in the entire measurement range, thereby calculating the number ratio of the Ag phase on the grain boundary.

TABLE 5
(Cu-1.0 mass % Ag alloy wire)

| | | | | | | | | Evaluation | | |
|---|---|---|---|---|---|---|---|---|---|---|
| | | | | | Metal structure | | | | Increase | |
| | | | | | Total | Number | Number | | in tensile | |
| | | | | | number of | ratio of | ratio of | Increase | strength | |
| | Cu—Ag alloy wire | | | | Ag phase | Ag phase | Ag phase | in | after | |
| | Shape of | Wire | Sectional | D | per unit | satisfying | on grain | tensile | reheat | |
| | Cu—Ag | diameter | area σ | (×10⁻³ | area | formula | boundary | strength | treatment | Conductivity |
| | alloy wire | (mm) | (μm2) | μm) | (phase/μm2) | (1) (%) | (%) | (MPa) | (MPa) | (% IACS) |
| Example 1-1 | Round wire | 0.03 | 707 | 3.0 | 317 | 59.0 | 21.5 | 130 | 180 | 79.1 |
| Example 1-2 | Round wire | 0.03 | 707 | 3.0 | 365 | 65.0 | 13.0 | 120 | 140 | 82.2 |
| Example 1-3 | Round wire | 0.03 | 707 | 3.0 | 475 | 92.5 | 32.0 | 180 | 220 | 76.9 |
| Example 1-4 | Round wire | 0.03 | 707 | 3.0 | 506 | 62.5 | 18.0 | 150 | 180 | 80.6 |
| Example 1-5 | Round wire | 0.03 | 707 | 3.0 | 428 | 61.5 | 17.0 | 160 | 150 | 80.2 |
| Example 1-6 | Round wire | 0.03 | 707 | 3.0 | 417 | 83.0 | 33.5 | 190 | 260 | 78.4 |
| Example 1-7 | Round wire | 0.03 | 707 | 3.0 | 450 | 66.0 | 27.0 | 170 | 210 | 79.6 |
| Example 1-8 | Round wire | 0.03 | 707 | 3.0 | 487 | 56.0 | 24.5 | 130 | 180 | 78.0 |
| Example 1-9 | Ribbon wire | Sheet | 707 | 3.0 | 405 | 58.0 | 24.5 | 120 | 180 | 79.2 |
| | | thickness: | | | | | | | | |
| | | 0.008 | | | | | | | | |
| | | Width: 0.08 | | | | | | | | |
| Example 1-10 | Round wire | 0.01 | 79 | 1.0 | 1233 | 64.0 | 21.0 | 120 | 220 | 79.4 |
| Example 1-11 | Round wire | 0.08 | 5027 | 8.0 | 154 | 55.5 | 23.0 | 100 | 180 | 81.7 |
| Comparative | Round wire | 0.03 | 707 | 3.0 | 230 | 0.0 | 14.0 | Reference | Reference | 90.6 |
| Example1-1 | | | | | | | | | | |
| Comparative | Round wire | 0.03 | 707 | 3.0 | 189 | 0.0 | 11.5 | 20 | 20 | 91.2 |
| Example1-2 | | | | | | | | | | |
| Comparative | Round wire | 0.03 | 707 | 3.0 | 123 | 13.5 | 7.5 | 30 | 20 | 87.2 |
| Example1-3 | | | | | | | | | | |
| Comparative | Round wire | 0.03 | 707 | 3.0 | 181 | 24.0 | 11.0 | 20 | 30 | 89.5 |
| Example1-4 | | | | | | | | | | |
| Comparative | Round wire | 0.03 | 707 | 3.0 | 205 | 29.5 | 12.5 | 40 | 60 | 88.3 |
| Example1-5 | | | | | | | | | | |
| Comparative | Round wire | 0.03 | 707 | 3.0 | 197 | 33.0 | 12.0 | 60 | 50 | 89.2 |
| Example1-6 | | | | | | | | | | |
| Comparative | Round wire | 0.03 | 707 | 3.0 | 156 | 27.0 | 9.5 | 50 | 40 | 87.3 |
| Example1-7 | | | | | | | | | | |
| Comparative | Round wire | 0.03 | 707 | 3.0 | 205 | 31.5 | 12.5 | 90 | 80 | 89.9 |
| Example1-8 | | | | | | | | | | |
| Comparative | Round wire | 0.03 | 707 | 3.0 | 197 | 36.0 | 12.0 | 60 | 70 | 93.1 |
| Example1-9 | | | | | | | | | | |
| Comparative | Round wire | 0.03 | 707 | 3.0 | 238 | 29.0 | 14.5 | 40 | 80 | 90.5 |
| Example1-10 | | | | | | | | | | |
| Comparative | Round wire | 0.03 | 707 | 3.0 | 214 | 31.5 | 13.0 | 60 | 40 | 89.4 |
| Example1-11 | | | | | | | | | | |

*Those outside the range of the present invention are indicated by underlines and italics.
Increase in tensile strength in examples and comparative examples as indicated with reference to comparative example 1-1 (tensile strength of 920 Mpa and 720 MPa after reheat treatment).

As shown in Tables 1 and 5, in the case of the Cu—Ag alloy wire in which the content of Ag is 1.0 mass %, a sufficient conductivity and a high tensile strength as compared with Comparative Example 1-1 (tensile strength of 920 MPa and tensile strength after reheat treatment of 720 MPa) are confirmed in Examples 1-1 to 1-11 in which the number ratio of the Ag phase is 50% or more in the formula (1), and it is confirmed that the tensile strength is sufficiently high even after the reheat treatment.

In addition, it is confirmed that in Examples 1-1 and 1-3 to 1-11 in which the number ratio of the Ag phase on the grain boundary is 15% or more and 35% or less, the increase in the tensile strength after the reheat treatment is particularly large and the tensile strength is excellent.

TABLE 6
(Cu-2.0 mass % Ag alloy wire)

| | | | | | | | | Evaluation | | |
|---|---|---|---|---|---|---|---|---|---|---|
| | | | | | Metal structure | | | | Increase | |
| | | | | | Total | Number | Number | | in tensile | |
| | | | | | number of | ratio of | ratio of | Increase | strength | |
| | Cu—Ag alloy wire | | | | Ag phase | Ag phase | Ag phase | in | after | |
| | Shape of | Wire | Sectional | D | per unit | satisfying | on grain | tensile | reheat | |
| | Cu—Ag | diameter | area σ | (×10 − 3 | area | formula | boundary | strength | treatment | Conductivity |
| | alloy wire | (mm) | (μm2) | μm) | (phase/μm2) | (1) (%) | (%) | (MPa) | (MPa) | (% IACS) |
| Example 2-1 | Round wire | 0.03 | 707 | 3.0 | 1099 | 58.5 | 24.0 | 120 | 190 | 76.4 |
| Example 2-2 | Round wire | 0.03 | 707 | 3.0 | 1269 | 60.5 | 14.0 | 150 | 130 | 76.5 |
| Example 2-3 | Round wire | 0.03 | 707 | 3.0 | 1413 | 95.0 | 29.0 | 170 | 220 | 72.3 |
| Example 2-4 | Round wire | 0.03 | 707 | 3.0 | 1446 | 62.0 | 19.5 | 140 | 160 | 78.0 |
| Example 2-5 | Round wire | 0.03 | 707 | 3.0 | 1444 | 66.5 | 18.0 | 110 | 160 | 78.2 |
| Example 2-6 | Round wire | 0.03 | 707 | 3.0 | 1328 | 90.5 | 31.0 | 180 | 170 | 73.2 |
| Example 2-7 | Round wire | 0.03 | 707 | 3.0 | 1327 | 58.0 | 27.0 | 130 | 180 | 78.2 |
| Example 2-8 | Round wire | 0.03 | 707 | 3.0 | 1197 | 54.5 | 25.5 | 120 | 170 | 76.2 |
| Example 2-9 | Ribbon wire | Sheet | 707 | 3.0 | 1222 | 53.0 | 18.5 | 140 | 150 | 77.2 |
| | | thickness: | | | | | | | | |
| | | 0.008 | | | | | | | | |
| | | Width: 0.08 | | | | | | | | |
| Example 2-10 | Round wire | 0.01 | 79 | 1.0 | 3749 | 67.0 | 23.0 | 130 | 170 | 78.5 |
| Example 2-11 | Round wire | 0.08 | 5027 | 8.0 | 469 | 52.0 | 21.5 | 110 | 180 | 81.3 |
| Comparative | Round wire | 0.03 | 707 | 3.0 | 625 | 0.0 | 12.5 | Reference | Reference | 88.5 |
| Example2-1 | | | | | | | | | | |
| Comparative | Round wire | 0.03 | 707 | 3.0 | 600 | 0.0 | 12.0 | 10 | 0 | 86.0 |
| Example2-2 | | | | | | | | | | |
| Comparative | Round wire | 0.03 | 707 | 3.0 | 600 | 18.5 | 12.0 | 30 | 60 | 78.4 |
| Example2-3 | | | | | | | | | | |
| Comparative | Round wire | 0.03 | 707 | 3.0 | 550 | 23.0 | 11.0 | 20 | 0 | 81.5 |
| Example2-4 | | | | | | | | | | |
| Comparative | Round wire | 0.03 | 707 | 3.0 | 550 | 25.5 | 11.0 | 20 | 10 | 81.1 |
| Example2-5 | | | | | | | | | | |
| Comparative | Round wire | 0.03 | 707 | 3.0 | 625 | 37.0 | 12.5 | 60 | 30 | 82.5 |
| Example2-6 | | | | | | | | | | |
| Comparative | Round wire | 0.03 | 707 | 3.0 | 450 | 24.0 | 9.0 | 30 | −20 | 79.7 |
| Example2-7 | | | | | | | | | | |
| Comparative | Round wire | 0.03 | 707 | 3.0 | 400 | 42.0 | 8.0 | 80 | 20 | 82.8 |
| Example2-8 | | | | | | | | | | |
| Comparative | Round wire | 0.03 | 707 | 3.0 | 575 | 39.5 | 11.5 | 50 | 30 | 82.9 |
| Example2-9 | | | | | | | | | | |
| Comparative | Round wire | 0.03 | 707 | 3.0 | 700 | 23.5 | 14.0 | 20 | 50 | 82.3 |
| Example2-10 | | | | | | | | | | |
| Comparative | Round wire | 0.03 | 707 | 3.0 | 650 | 38.0 | 13.0 | 40 | 0 | 82.6 |
| Example2-11 | | | | | | | | | | |

*Those outside the range of the present invention are indicated by underlines and italics.
Increase in tensile strength in examples and comparative examples as indicated with reference to comparative example 2-1 (tensile strength of 1020 Mpa and 860 MPa after reheat treatment).

As shown in Tables 2 and 6, in the case of the Cu—Ag alloy wire in which the content of Ag is 2.0 mass %, a sufficient conductivity and a sufficiently high tensile strength as compared with Comparative Example 2-1 (tensile strength of 1,020 MPa and tensile strength after reheat treatment of 860 MPa) are confirmed in Examples 2-1 to 2-11 in which the number ratio of the Ag phase is 50% or more in the formula (1), and it is confirmed that the tensile strength is sufficiently high even after the reheat treatment.

In addition, it is confirmed that in Examples 2-1 and 2-3 to 2-11 in which the number ratio of the Ag phase on the grain boundary is 15% or more and 35% or less, the increase in the tensile strength after the reheat treatment is particularly large and the tensile strength is excellent.

TABLE 7
(Cu-4.0 mass % Ag alloy wire)

| | | | | | | | | Evaluation | | |
|---|---|---|---|---|---|---|---|---|---|---|
| | | | | | Metal structure | | | | Increase | |
| | | | | | Total | Number | Number | | in tensile | |
| | | | | | number of | ratio of | ratio of | Increase | strength | |
| | Cu—Ag alloy wire | | | | Ag phase | Ag phase | Ag phase | in | after | |
| | Shape of | Wire | Sectional | D | per unit | satisfying | on grain | tensile | reheat | |
| | Cu—Ag | diameter | area σ | (×10 − 3 | area | formula | boundary | strength | treatment | Conductivity |
| | alloy wire | (mm) | (μm2) | μm) | (phase/μm2) | (1) (%) | (%) | (MPa) | (MPa) | (% IACS) |
| Example 3-1 | Round wire | 0.03 | 707 | 3.0 | 2897 | 54.5 | 22.5 | 135 | 190 | 69.6 |
| Example 3-2 | Round wire | 0.03 | 707 | 3.0 | 2800 | 58.0 | 13.5 | 145 | 140 | 68.3 |
| Example 3-3 | Round wire | 0.03 | 707 | 3.0 | 2668 | 91.5 | 31.0 | 185 | 210 | 61.1 |
| Example 3-4 | Round wire | 0.03 | 707 | 3.0 | 2792 | 63.0 | 23.0 | 165 | 180 | 67.4 |
| Example 3-5 | Round wire | 0.03 | 707 | 3.0 | 2633 | 64.0 | 17.5 | 135 | 180 | 69.7 |
| Example 3-6 | Round wire | 0.03 | 707 | 3.0 | 2927 | 78.5 | 34.0 | 170 | 200 | 62.8 |
| Example 3-7 | Round wire | 0.03 | 707 | 3.0 | 3074 | 52.5 | 28.0 | 110 | 160 | 69.0 |
| Example 3-8 | Round wire | 0.03 | 707 | 3.0 | 2896 | 57.5 | 27.5 | 155 | 180 | 67.7 |
| Example 3-9 | Ribbon wire | Sheet | 707 | 3.0 | 3107 | 55.0 | 18.5 | 155 | 170 | 69.2 |
| | | thickness: | | | | | | | | |
| | | 0.008 | | | | | | | | |
| | | Width: 0.08 | | | | | | | | |
| Example 3-10 | Round wire | 0.01 | 79 | 1.0 | 8780 | 54.5 | 24.0 | 155 | 200 | 69.3 |
| Example 3-11 | Round wire | 0.08 | 5027 | 8.0 | 1098 | 58.0 | 23.5 | 120 | 180 | 71.5 |
| Comparative | Round wire | 0.03 | 707 | 3.0 | 1522 | 0.0 | 13.0 | Reference | Reference | 77.8 |
| Example3-1 | | | | | | | | | | |
| Comparative | Round wire | 0.03 | 707 | 3.0 | 1580 | 0.0 | 13.5 | 15 | −10 | 78.3 |
| Example3-2 | | | | | | | | | | |
| Comparative | Round wire | 0.03 | 707 | 3.0 | 878 | 14.5 | 7.5 | 40 | 10 | 73.1 |
| Example3-3 | | | | | | | | | | |
| Comparative | Round wire | 0.03 | 707 | 3.0 | 1288 | 28.0 | 11.0 | 45 | 40 | 74.2 |
| Example3-4 | | | | | | | | | | |
| Comparative | Round wire | 0.03 | 707 | 3.0 | 1171 | 23.5 | 10.0 | 55 | 20 | 74.9 |
| Example3-5 | | | | | | | | | | |
| Comparative | Round wire | 0.03 | 707 | 3.0 | 1229 | 36.0 | 10.5 | 35 | 20 | 75.3 |
| Example3-6 | | | | | | | | | | |
| Comparative | Round wire | 0.03 | 707 | 3.0 | 1580 | 36.5 | 13.5 | 35 | 30 | 76.1 |
| Example3-7 | | | | | | | | | | |
| Comparative | Round wire | 0.03 | 707 | 3.0 | 1405 | 33.0 | 12.0 | 65 | 50 | 75.5 |
| Example3-8 | | | | | | | | | | |
| Comparative | Round wire | 0.03 | 707 | 3.0 | 1580 | 34.0 | 13.5 | 15 | 70 | 75.2 |
| Example3-9 | | | | | | | | | | |
| Comparative | Round wire | 0.03 | 707 | 3.0 | 1054 | 22.5 | 9.0 | 45 | 10 | 73.4 |
| Example3-10 | | | | | | | | | | |
| Comparative | Round wire | 0.03 | 707 | 3.0 | 1288 | 37.0 | 11.0 | 45 | 50 | 75.8 |
| Example3-11 | | | | | | | | | | |

*Those outside the range of the present invention are indicated by underlines and italics.
Increase in tensile strength in examples and comparative examples as indicated with reference to comparative example 3-1 (tensile strength of 1235 Mpa and 1060 MPa after reheat treatment).

As shown in Tables 3 and 7, in the case of the Cu—Ag alloy wire in which the content of Ag is 4.0 mass %, a sufficient conductivity and a sufficiently high tensile strength as compared with Comparative Example 3-1 (tensile strength of 1,235 Mpa and tensile strength after reheat treatment of 1,060 MPa) are confirmed in Examples 3-1 to 3-11 in which the number ratio of the Ag phase is 50% or more in the formula (1), and it is confirmed that the tensile strength is sufficiently high even after the reheat treatment.

In addition, it is confirmed that in Examples 3-1 and 3-3 to 3-11 in which the number ratio of the Ag phase on the grain boundary is 15% or more and 35% or less, the increase in the tensile strength after the reheat treatment is particularly large and the tensile strength is excellent.

TABLE 8
(Cu-6.0 mass % Ag alloy wire)

| | | | | | | | | Evaluation | | |
|---|---|---|---|---|---|---|---|---|---|---|
| | | | | | Metal structure | | | | Increase | |
| | | | | | Total | Number | Number | | in tensile | |
| | | | | | number of | ratio of | ratio of | Increase | strength | |
| | Cu—Ag alloy wire | | | | Ag phase | Ag phase | Ag phase | in | after | |
| | Shape of | Wire | Sectional | D | per unit | satisfying | on grain | tensile | reheat | |
| | Cu—Ag | diameter | area σ | (×10 − 3 | area | formula | boundary | strength | treatment | Conductivity |
| | alloy wire | (mm) | (μm2) | μm) | (phase/μm2) | (1) (%) | (%) | (MPa) | (MPa) | (% IACS) |
| Example 4-1 | Round wire | 0.03 | 707 | 3.0 | 4931 | 56.5 | 23.0 | 120 | 160 | 57.3 |
| Example 4-2 | Round wire | 0.03 | 707 | 3.0 | 4562 | 54.0 | 12.0 | 140 | 140 | 59.7 |
| Example 4-3 | Round wire | 0.03 | 707 | 3.0 | 4948 | 97.0 | 32.0 | 185 | 210 | 52.4 |
| Example 4-4 | Round wire | 0.03 | 707 | 3.0 | 4701 | 58.5 | 19.5 | 130 | 170 | 59.9 |
| Example 4-5 | Round wire | 0.03 | 707 | 3.0 | 4634 | 58.0 | 17.5 | 120 | 170 | 59.0 |
| Example 4-6 | Round wire | 0.03 | 707 | 3.0 | 4328 | 83.5 | 33.5 | 160 | 200 | 53.4 |
| Example 4-7 | Round wire | 0.03 | 707 | 3.0 | 4593 | 54.0 | 25.0 | 110 | 190 | 59.0 |
| Example 4-8 | Round wire | 0.03 | 707 | 3.0 | 4302 | 64.5 | 27.0 | 130 | 210 | 59.1 |
| Example 4-9 | Ribbon wire | Sheet | 707 | 3.0 | 4338 | 57.0 | 20.0 | 140 | 150 | 57.7 |
| | | thickness: | | | | | | | | |
| | | 0.008 | | | | | | | | |
| | | Width: 0.08 | | | | | | | | |
| Example 4-10 | Round wire | 0.01 | 79 | 1.0 | 13812 | 62.0 | 24.0 | 150 | 190 | 58.7 |
| Example 4-11 | Round wire | 0.08 | 5027 | 8.0 | 1726 | 56.5 | 25.5 | 100 | 200 | 61.1 |
| Comparative | Round wire | 0.03 | 707 | 3.0 | 2302 | 0.0 | 12.5 | Reference | Reference | 63.8 |
| Example4-1 | | | | | | | | | | |
| Comparative | Round wire | 0.03 | 707 | 3.0 | 2578 | 0.0 | 14.0 | 0 | 20 | 64.4 |
| Example4-2 | | | | | | | | | | |
| Comparative | Round wire | 0.03 | 707 | 3.0 | 1842 | 15.0 | 10.0 | 20 | 10 | 64.7 |
| Example4-3 | | | | | | | | | | |
| Comparative | Round wire | 0.03 | 707 | 3.0 | 2210 | 28.0 | 12.0 | 40 | 30 | 65.5 |
| Example4-4 | | | | | | | | | | |
| Comparative | Round wire | 0.03 | 707 | 3.0 | 2026 | 21.5 | 11.0 | 10 | 40 | 65.3 |
| Example4-5 | | | | | | | | | | |
| Comparative | Round wire | 0.03 | 707 | 3.0 | 2394 | 36.0 | 13.0 | 0 | 0 | 66.7 |
| Example4-6 | | | | | | | | | | |
| Comparative | Round wire | 0.03 | 707 | 3.0 | 1749 | 26.5 | 9.5 | 30 | 20 | 59.9 |
| Example4-7 | | | | | | | | | | |
| Comparative | Round wire | 0.03 | 707 | 3.0 | 2210 | 37.5 | 12.0 | 70 | 10 | 66.4 |
| Example4-8 | | | | | | | | | | |
| Comparative | Round wire | 0.03 | 707 | 3.0 | 2486 | 33.5 | 13.5 | 50 | 40 | 66.1 |
| Example4-9 | | | | | | | | | | |
| Comparative | Round wire | 0.03 | 707 | 3.0 | 2578 | 29.0 | 14.0 | 20 | 30 | 60.9 |
| Example4-10 | | | | | | | | | | |
| Comparative | Round wire | 0.03 | 707 | 3.0 | 2394 | 31.0 | 13.0 | 20 | 30 | 66.7 |
| Example4-11 | | | | | | | | | | |

*Those outside the range of the present invention are indicated by underlines and italics.
Increase in tensile strength in examples and comparative examples as indicated with reference to comparative example 4-1 (tensile strength of 1470 Mpa and 1270 MPa after reheat treatment).

As shown in Tables 4 and 8, in the case of the Cu—Ag alloy wire in which the content of Ag is 6.0 mass %, a sufficient conductivity and a sufficiently high tensile strength as compared with Comparative Example 4-1 (tensile strength of 1,470 MPa and tensile strength after reheat treatment of 1,270 MPa) are confirmed in Examples 4-1 to 4-11 in which the number ratio of the Ag phase is 50% or more in the formula (1), and it is confirmed that the tensile strength is sufficiently high even after the reheat treatment.

In addition, it is confirmed that in Examples 4-1 and 4-3 to 4-11 in which the number ratio of the Ag phase on the grain boundary is 15% or more and 35% or less, the increase in the tensile strength after the reheat treatment is particularly large and the tensile strength is excellent.

### 2. Experiment 2: Manufacture and Evaluation of Cu—Ag Alloy Wire Containing Additive Element

Cu—Ag alloy wires of Examples 5-1 to 5-8 and Comparative Example 5-1 were manufactured under the manufacturing conditions shown in Table 9 in the same manner as in Examples 2-1 to 2-11 of Experiment 1 except that a predetermined addition amount of the auxiliary additive element shown in Table 9 was added, and were evaluated in the same manner as in Experiment 1. Comparative Example 5-1 was used as a control of the tensile test.

TABLE 9
(Addition of auxiliary additive element: Cu-2.0 mass % Ag alloy wire)

| | | | Manufacturing condition | | | | | | | |
|---|---|---|---|---|---|---|---|---|---|---|
| | Composition | | Cooling | First wire | | | | | | Second wire |
| | Auxiliary | | step after | drawing | First heat | | | Second heat | | drawing |
| | additive element | | casting | step | treatment step | | | treatment step | | step |
| | | Addition | Cooling | Processing | Holding | Holding | Cooling | Holding | Holding | Processing |
| | | amount | rate | ratio | temperature | time | rate | temperature | time | ratio |
| | Element | (mass %) | (° C./sec) | (%) | (° C.) | (h) | (° C./s) | (° C.) | (h) | (%) |
| Example 5-1 | Sn | 0.1 | 80 | 60 | 350 | 10 | 100 | 450 | 10 | 99.998 |
| Example 5-2 | Mg | 0.1 | 80 | 60 | 350 | 10 | 100 | 450 | 10 | 99.998 |
| Example 5-3 | Zn | 0.3 | 80 | 60 | 350 | 10 | 100 | 450 | 10 | 99.998 |
| Example 5-4 | In | 0.1 | 80 | 60 | 350 | 10 | 100 | 450 | 10 | 99.998 |
| Example 5-5 | Ni | 0.2 | 80 | 60 | 350 | 10 | 100 | 450 | 10 | 99.998 |
| Example 5-6 | Co | 0.1 | 80 | 60 | 350 | 10 | 100 | 450 | 10 | 99.998 |
| Example 5-7 | Zr | 0.05 | 80 | 60 | 350 | 10 | 100 | 450 | 10 | 99.998 |
| Example 5-8 | Cr | 0.1 | 80 | 60 | 350 | 10 | 100 | 450 | 10 | 99.998 |
| Comparative | Sn | 0.1 | 80 | 60 | — | — | — | — | — | 99.998 |
| Example5-1 | | | | | | | | | | |

TABLE 10
(Addition of auxiliary additive element: Cu-2.0 mass % Ag alloy wire)

| | | | | | | | | Evaluation | | |
|---|---|---|---|---|---|---|---|---|---|---|
| | | | | | Metal structure | | | | Increase | |
| | | | | | Total | Number | Number | | in tensile | |
| | | | | | number of | ratio of | ratio of | Increase | strength | |
| | Cu—Ag alloy wire | | | | Ag phase | Ag phase | Ag phase | in | after | |
| | Shape of | Wire | Sectional | D | per unit | satisfying | on grain | tensile | reheat | |
| | Cu—Ag | diameter | area σ | (×10 − 3 | area | formula | boundary | strength | treatment | Conductivity |
| | alloy wire | (mm) | (μm2) | μm) | (phase/μm2) | (1) (%) | (%) | (MPa) | (MPa) | (% IACS) |
| Example 5-1 | Round wire | 0.03 | 707 | 3.0 | 1058 | 52.0 | 23.5 | 160 | 180 | 72.9 |
| Example 5-2 | Round wire | 0.03 | 707 | 3.0 | 1335 | 57.5 | 25.0 | 180 | 200 | 73.1 |
| Example 5-3 | Round wire | 0.03 | 707 | 3.0 | 1282 | 57.0 | 22.0 | 150 | 170 | 77.6 |
| Example 5-4 | Round wire | 0.03 | 707 | 3.0 | 1294 | 54.0 | 22.5 | 180 | 180 | 73.8 |
| Example 5-5 | Round wire | 0.03 | 707 | 3.0 | 1415 | 65.5 | 24.5 | 130 | 160 | 75.7 |
| Example 5-6 | Round wire | 0.03 | 707 | 3.0 | 1322 | 53.5 | 21.0 | 130 | 160 | 77.6 |
| Example 5-7 | Round wire | 0.03 | 707 | 3.0 | 1272 | 57.0 | 27.0 | 170 | 200 | 72.8 |
| Example 5-8 | Round wire | 0.03 | 707 | 3.0 | 1240 | 62.5 | 26.0 | 130 | 190 | 78.2 |
| Comparative | Round wire | 0.03 | 707 | 3.0 | 1178 | 0.0 | 12.5 | Reference | Reference | 82.6 |
| Example5-1 | | | | | | | | | | |

*Those outside the range of the present invention are indicated by underlines and italics.
Increase in tensile strength in examples and comparative examples as indicated with reference to comparative example 5-1 (tensile strength of 1,060 Mpa and 900 MPa after reheat treatment).

As shown in Tables 9 and 10, in the case of the Cu—Ag alloy wire in which the auxiliary additive element is added in a range of 0.05 mass % or more and 0.30 mass % or less, a sufficient conductivity and a sufficiently high tensile strength as compared with Comparative Example 5-1 (tensile strength of 1,060 MPa and tensile strength after reheat treatment of 900 MPa) are confirmed in Examples 5-1 to 5-8 in which the number ratio of the Ag phase is 50% or more in the formula (1), and it is confirmed that the tensile strength is sufficiently high even after the reheat treatment.

In addition, it is confirmed that in Examples 5-1 to 5-8 in which the number ratio of the Ag phase on the grain boundary is 15% or more and 35% or less, the increase in the tensile strength after the reheat treatment is particularly large and the tensile strength is excellent.

TABLE 11
(Addition of auxiliary additive element:
Cu-2.0 mass % Ag alloy wire)

| | |
|---|---|
| Composition | Evaluation |

| | |
|---|---|
| Auxiliary | Tensile |
| additive element | strength after |

| | | Addition | Tensile | reheat |
|---|---|---|---|---|
| | | amount | strength | treatment |
| | Element | (mass %) | (Mpa) | (MPa) |
| Example 2-1 | None | — | 1140 | 1050 |
| Example 5-1 | Sn | 0.1 | 1220 | 1080 |
| Example 5-2 | Mg | 0.1 | 1240 | 1100 |
| Example 5-3 | Zn | 0.3 | 1210 | 1070 |
| Example 5-4 | In | 0.1 | 1240 | 1080 |
| Example 5-5 | Ni | 0.2 | 1190 | 1060 |
| Example 5-6 | Co | 0.1 | 1190 | 1060 |
| Example 5-7 | Zr | 0.05 | 1230 | 1100 |
| Example 5-8 | Cr | 0.1 | 1190 | 1090 |

As shown in Table 11, it is confirmed that in Examples 5-1 to 5-8 manufactured by adding an auxiliary additive element, both the tensile strength and the tensile strength after the reheat treatment are high, and both the tensile strength and the tensile strength after the reheat treatment can be increased by adding an auxiliary additive element, as compared with Example 2-1 manufactured under the same conditions with the same Ag content of 2.0 mass %.

### EXPLANATION OF REFERENCE NUMERALS

1 Cu phase
2 coarse Ag phase
2f fibrous coarse Ag phase
3 fine Ag phase
3f fibrous fine Ag phase
10, 10a, 10b, 10c, 20, 20a, and 20b Cu—Ag alloy material

1. A Cu—Ag alloy wire comprising: a composition containing 1 mass % or more and 6 mass % or less of Ag and a balance of Cu and inevitable impurities,
the Cu—Ag alloy wire having a metal structure including a Cu phase as a matrix and a plurality of Ag phases as a second phase,
the following formula (1) being satisfied with σ (μm²) being a sectional area of a cross section orthogonal to a longitudinal direction of the Cu—Ag alloy wire and D (μm) being a diameter of a true circle having an area same as each of the Ag phases present in the cross section:
$$\begin{matrix}[ Math . 1 ] & \\ D ≦ \sqrt{\frac{σ}{0.25 π}} \times {10}^{- 4} & Formula ( 1 )\end{matrix}$$
wherein π represents a circular constant,
a ratio of the number of Ag phases having a diameter D of less than 5 nm to the total number of Ag phases being 50% or more.

2. The Cu—Ag alloy wire according to claim 1, wherein in the cross section of the Cu—Ag alloy wire,
a ratio of the number of Ag phases present on a grain boundary of the Cu phase to the total number of Ag phases is 15% or more and 35% or less.

3. The Cu—Ag alloy wire according to claim 1, wherein the composition further contains at least one kind of auxiliary additive element selected from the group consisting of Sn, Mg, Zn, In, Ni, Co, Zr, and Cr in a range of 0.05 mass % or more and 0.3 mass % or less.

4. The Cu—Ag alloy wire according to claim 1, wherein the Cu—Ag alloy wire is a round wire having a wire diameter of 0.01 mm or more and 0.08 mm or less.

5. The Cu—Ag alloy wire according to claim 1, wherein the Cu—Ag alloy wire is a ribbon wire having a substantially rectangular cross-sectional shape having a width of 0.02 mm or more and 0.32 mm or less and a thickness of 0.002 mm or more and 0.04 mm or less.
